(19) United States
(12) Patent Application Publication
(10) Pub. No.: US 2024/0093882 A1
(43) Pub. Date: Mar. 21, 2024

(54) HOT WATER SUPPLY

(71) Applicant: OCTOPUS ENERGY HEATING LIMITED, London (GB)

(72) Inventor: Peter KONOWALCZYK, London (GB)

(73) Assignee: OCTOPUS ENERGY HEATING LIMITED, London (GB)

(21) Appl. No.: 18/276,006

(22) PCT Filed: Feb. 7, 2022
(86) PCT No.: PCT/IB2022/051085

§ 371 Date: Aug. 4, 2023

(30) Foreign Application Priority Data
Feb. 7, 2021 (GB) 2101678.7
Jul. 2, 2021 (GB) 2109593.0
Jul. 2, 2021 (GB) 2109594.8
Jul. 2, 2021 (GB) 2109596.3
Jul. 2, 2021 (GB) 2109597.1
Jul. 2, 2021 (GB) 2109598.9
Jul. 2, 2021 (GB) 2109599.7
Jul. 2, 2021 (GB) 2109600.3

(51) Int. Cl. F24D 17/02; F24D 19/10; F24H 15/212; F24H 15/238; F24H 15/31

(52) U.S. Cl. CPC F24D 17/02; F24D 19/1054; F24H 15/212; F24H 15/238; F24H 15/31; F24D 2220/042; F24D 2220/044

(57) ABSTRACT

A hot water supply system 400 comprises a cold water inlet 402 coupled to a valve 404 which determines the degree of flow in a first path 406 and a second path 408. The first path comprises an Energy Storage Arrangement including a heat exchanger 410 which can heat the water from the inlet. The second path includes an electrical heater 422 which can also heat water from the inlet. The two paths each include a respective flow sensor 416, 428 and the paths re-join before providing an outlet 420 from the supply system via a temperature sensor 418. A controller 430 controls the valve 404 and the electrical heater 422 in response to the sensor signals to provide hot water at a desired temperature using a suitable proportion of stored energy and electrical energy. By charging the Energy Storage Arrangement using a heat pump, an economical and responsive hot water supply system is provided.

### TECHNICAL FIELD

The present disclosure variously relates to methods, systems and apparatus for installations including an in-building hot water supply system (HWSS) including an energy storage arrangement based on phase change materials.

### BACKGROUND

Domestic and small commercial premises often meet requirements for hot water by a gas-fired boiler or furnace. Either the water is heated and stored in a tank of some kind or is heated on-demand when a hot tap (faucet) is opened on the premises. With increasing concern over the environmental damage caused by burning fossil fuels, attention has turned to alternative techniques to provide hot water, such as heat pumps.

Heat pumps use refrigeration technology to extract heat from a lower-temperature resource and transfer that heat to a higher-temperature resource. A heat pump can, for example, extract heat from air at, say 15 degrees centigrade, and heat water to a temperature of, say 50 degrees centigrade. Such a heat pump is called an air-source heat pump although water-source and ground-source heat pumps are also available and work on the same principle. Despite the (usually electrical) energy required to operate them, heat pumps can be up to four or more times as efficient as, for example, an electrical heater.

However, heat pumps are unable to match the responsiveness of an electrical heater or gas boiler, there being a delay of up to several minutes between power-up and supply of heated water. In addition, heat pumps usually have a limit on how often they can be activated (for instance 6 times per hour) and can be unavailable for periods of time such as during a defrost cycle.

### SUMMARY

According to a first aspect of the present invention there is provided a hot water supply system for a domestic dwelling comprising:
a cold-water inlet and a hot-water outlet,
an energy storage arrangement, which contains a mass of phase-change material, for connection to a heat pump,
a heat exchanger associated with the energy storage arrangement,
a supplementary heater,
at least one temperature sensor arranged to detect the temperature of water at least one of the hot-water outlet, the outlet of the heat exchanger and the outlet of the supplementary heater, and
a controller arranged to control at least the supplementary heater in response to a signal from the temperature sensor,
whereby the heat exchanger and the supplementary heater are arranged such that water from the cold-water inlet may be heated by passing through at least one of the heat exchanger and the supplementary heater and then provided to the hot-water outlet.

By providing an energy storage arrangement and a supplementary heater, the time delay to operation of a heat pump can be bridged.

The mass of phase-change material may have an energy storage capacity, based on the latent heat of the phase change material, of between 2 and 5 MJoules. An energy storage capacity in this range should be suitable for providing sufficient instantaneous hot water in applications where the energy storage arrangement is used to enable a heat pump to be used in place of a domestic gas combi boiler.

The supplementary heater can be electrically powered or gas-powered. An electrically-powered heater has the advantage that an electrical supply is already available to the heater although may cost more to operate than a gas-powered heater. On the other hand, a gas-powered heater may have the advantage of being cheaper to run when compared to an electrical device but doesn't address the problem of burning fossil fuels. As a more flexible but costly alternative, the supplementary heater could operate from either energy source.

The controller may be further arranged to send a start signal to a heat pump. In this case a flow rate sensor provides a flow rate measure to the controller. The controller may then be programmed to take into account the likely duration of hot water demand. For example, if a detected flow rate is commensurate with a basin tap then it may be assumed that water demand will be brief and there is no need to activate the heat pump. However, if the rate is commensurate with a shower or bath tap being turned on, then a greater demand will be assumed and the start signal will be sent to the heat pump.

The controller may be configured to activate the instantaneous water heater only when the energy storage arrangement and the heat pump are unable to provide sufficient hot water. In this way, “green” energy supplied from the heat pump may be used preferentially compared to electricity supplied from the mains (for example) which may have been generated by burning fossil fuels.

The controller may be configured to control the instantaneous water heater, based on information about the status of the phase-change material (PCM) and of the heat pump. For example, if the PCM is depleted and the heat pump unavailable (for example because it has been started too many times in a given period or was too recently run), the instantaneous water heater may be used to compensate for the lack of availability of energy from the PCM and the heat pump. Whereas if the PCM is fully “charged” and/or the heat pump is available, the processor may determine not to use the instantaneous water heater.

The controller may be provided with logic to manage the use of the instantaneous water heater, the heat pump, and energy from the phase change material to reduce energy consumption. This may reduce the cost of heating water, and may also favour “green” energy over energy derived from fossil fuels. If the controller adopts a more cost-based approach, the controller is preferably provided with up-to-date tariff information. The controller may also have access to information on household activity (past, present, and planned), occupancy information, weather forecasts and/or current weather conditions, etc.

The controller may be configured to rely preferentially on the energy storage arrangement and then the heat pump to provide sufficient hot water (as opposed to activating the supplementary heater). Such an approach can improve efficiency and reduce wear and tear on the heat pump and its components.

Two arrangements of the heat exchanger and the supplementary heater are possible.

In a first preferred embodiment, the energy storage arrangement (ESA) and the supplementary heater are connected in series, such that incoming cold-water is first heated by the ESA (via the heat exchanger) and then, if necessary, by the supplementary heater. That is to say that the incoming cold water first receives heat from the ESA via the heat exchanger and is then passed though the supplementary heater (typically an electrical heater). If the cold water gains enough heat from the ESA via the heat exchanger, then the electrical heater is not activated. That the water temperature is adequate may be detected by the temperature sensor at the output of the heat exchanger. At least two possible control strategies may be used. In the first, a temperature sensor detects the temperature of the water at the outlet of the heat exchanger and determines whether (and to what extent) to activate the supplementary heater. A flow sensor is also required so that control circuitry can determine the amount of heat required from the supplementary heater to ensure that water leaving the supplementary heater is at a desired temperature. In the second control strategy, a temperature sensor is provided at the output of the supplementary heater and a controller adjusts the power supplied to the heater in order to meet a predetermined target temperature for the water at the outlet of the supplementary heater.

The series arrangement has the advantage that there is a single path for water to be heated and requires few sensors and control valves.

However, providing only one path for water to be heated reduces the available flexibility in utilizing the two sources of heat.

In a second preferred embodiment, the ESA and the supplementary heater are connected in parallel, which is to say that the cold-water inlet is connected to both the heat exchanger associated with the ESA and to the supplementary heater. The output of the heat exchanger and the output of the supplementary heater are combined to provide the output of the HWSS. A control valve is arranged to control the relative flow in each path which might, for example, be a three-way valve or two separate valves located in each of the two water paths.

This arrangement requires more sensors and control valves but provides a number of advantages over the series arrangement, predominantly control over how much heat is extracted from the ESA. Two examples help to illustrate this.

Firstly, by providing a separate path for cold water (via the supplementary heater), it is possible to reduce the temperature of the water at the hot-water output of the HWSS. In the series arrangement, all of the water to be heated flows through the heat exchanger associated with the ESA. The amount of heat transferred to the incoming water by the heat exchanger is entirely dependent upon the flow rate which is set by the degree to which a user has opened one or more taps. This may result in too much heat being transferred (especially at low flow rates) with the consequence that the outlet water is too hot and energy stored in the ESA has been wasted. By routing some of the cold water through the (inactive) supplementary heater a precise control of outlet temperature may be achieved.

Secondly, there may be instances when it is desirable to use the supplementary heater in preference to extracting heat from the ESA. At certain times, electricity may be cheap and so it makes financial sense to use the supplementary heater to perform all (or at least the majority) of the heating of the water. This isn't possible using the series arrangement since all of the inlet water necessarily flows through the heat exchanger associated with the ESA.

Preferably, a temperature sensor coupled to the controller is provided at the outlet of the first path and at the outlet of the second path. This provides the opportunity for better control of the output temperature.

Preferably, the first and second paths both contain a flow sensor. This permits the controller to balance the flow through the heat exchanger and the supplementary heater.

The control valves are preferably controlled using a PWM signal generated by closed-loop control in response the outputs of the respective flow sensors. This permits the use of lower-precision valves while providing precise flow control.

In order to address possible valve failure, a second valve is provided on each of the first and second paths. Redundant operation can be provided by connecting the second valves in parallel with the first valves. The controller can infer valve failure generally from a zero or low flow rate despite attempted actuation of the corresponding valve.

The controller is preferably provided with inputs for at least two temperature sensors and at least two flow sensors and is arranged to determine, from the outputs of the temperature sensors and the flow sensors, whether water provided at the outlet is at a desired temperature. The controller is then able to balance the flow in the two paths to obtain the desired output temperature.

The controller may also be provided with an input for electricity tariff information, the controller being arranged to determine, in response to the tariff information, the extent to which the supplementary heater is to be activated and the relative flow rates in the first and second paths. This allows the controller to utilise cheap electricity when available.

The hot water supply system may further comprise a heat pump connected to the energy storage arrangement.

The capacity of the energy storage arrangement is preferably at least 5 MJ.

To further benefit from cheap electricity, the energy storage arrangement may further be provided with an electrical heater controlled by the controller. Energy may thus be provided to the ESA from either the heat pump or the electrical heater.

According to a second aspect of the present invention, there is provided a controller for controlling a hot water supply system according to the first aspect. The controller is provided with inputs for at least one temperature sensor and at least two flow sensors and is further arranged to determine, from the outputs of the temperature sensors and the flow sensors, the relative flow rates in the first and second paths.

Preferably, the controller further comprises an input for electricity tariff information, the controller then being arranged to determine, in response to the tariff information, the extent to which the supplementary heater is to be activated and the relative flow rates in the first and second paths.

The controller is preferably also arranged to determine, in response to an output from at least one flow sensor, whether to output a heat pump start signal.

### BRIEF DESCRIPTION OF THE DRAWINGS

Embodiments of various aspects of the disclosure will now be described, by way of example only, with reference to the accompanying drawings, in which:

FIG. 1 is a schematic diagram showing a potential arrangement of an installation including an in-building hot water supply system according to an aspect of the disclosure;

FIG. 2 is a schematic diagram showing a potential arrangement of components of an interface unit according to an aspect of the disclosure;

FIG. 3 shows a further embodiment having the heat exchanger and the supplementary heater in parallel, and

FIG. 4 shows another embodiment having a parallel arrangement.

### DETAILED DESCRIPTION

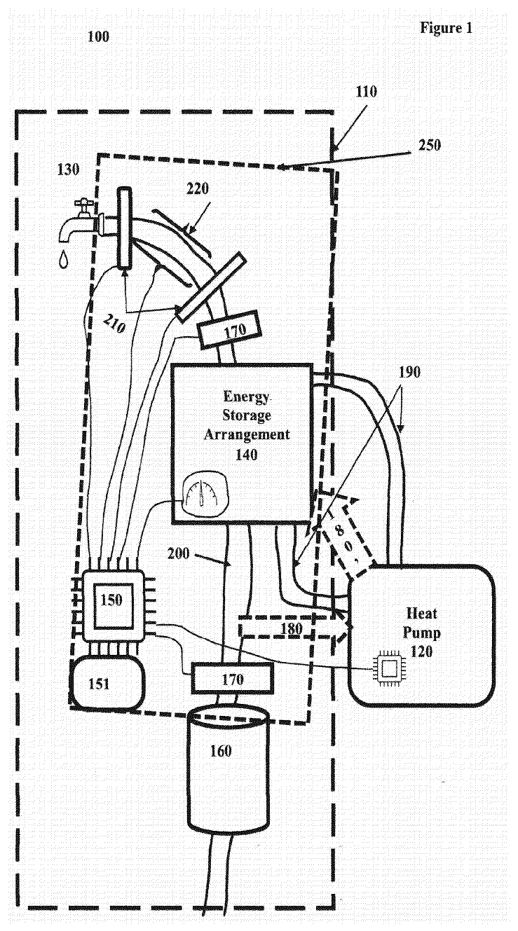

FIG. 1 illustrates schematically an installation according to a first aspect of the disclosure. The installation 100 includes an in-building hot water supply system (HWSS), represented by the box 110 and a heat pump 120 (which will generally be located outside the building), which is arranged to heat water in the HWSS 110. The HWSS includes at least one outlet 130 such as a tap or shower outlet. The HWSS further comprises an energy storage arrangement (ESA) 140 which contains a mass of phase change material (PCM). A processor 150, which may also be referred to as a system controller, is arranged to provide a signal to the heat pump 120 based on the opening of an outlet, such as outlet 130, of the hot water system.

The mass of phase change material has enough latent heat capacity to heat a predetermined quantity of water to a predetermined temperature in the interval from the opening of an outlet of the hot water supply system until at least the heat pump begins to heat water in the hot water supply system. A phase change material such as a paraffin having a phase transition temperature of 50° C. is suitable but alternatives and suitable combinations of materials will be apparent to the skilled reader.

The HWSS 110 is supplied with water to be heated, for example from a cold-water supply 160 and at least one flow transducer 170 is included in the flow path between the supply of water to be heated and the at least one outlet 130. Preferably the heat pump is arranged to heat water in the HWSS by means of a closed-loop arrangement, indicated schematically by pipework 190, and the supply of water to be heated is connected directly to the HWSS as shown by pipework 200. The flow transducer 170 may be located on the supply side of the hot water system, or on the outlet side of the whole system. The HWSS is provided with at least one temperature transducer 210. If only a single temperature transducer 210 is provided, this should be in the flow path between the energy storage arrangement 140 and the at least one outlet 130.

The HWSS 110 also includes an instantaneous supplementary water heater 220 in the flow path between the energy storage arrangement 140 and the at least one outlet 130. When an instantaneous water heater 220 is included in the HWSS, it is preferable to include a temperature transducer in the flow path between the energy storage arrangement and the instantaneous water heater, as well as one between the instantaneous water heater and the at least one outlet 130. The instantaneous water heater 220 is preferably an electrical heater.

The processor 150 is coupled to the flow transducer 170, to memory 151, to each of the temperature transducers 210, and to the heat pump. In addition, one or more sensing arrangements in the ESA are preferably coupled to the processor, so that the processor is aware of the status of the ESA. The processor 150 is also connected to instantaneous water heater 220.

With the preferred configuration in which the heat pump heats water in the HWSS by means of a closed loop arrangement, a heat exchanger, not shown, receives on one side liquid heated by the heat pump, and on another side water in the HWSS which is to be heated. Preferably, the heat exchanger forms part of the ESA. Preferably, the heat exchanger includes some or all of the mass of phase change material.

As shown in FIG. 1, by virtue of its size, the heat pump is typically located outside the building that houses the HWSS. The heat pump, whether it is mounted outside or within the building, will typically take 30 to 60 seconds to start to provide heat after having received a start signal. This is because an internal processor of the heat pump typically has to make checks on several components and subsystems, and also because of the inherent lag in the starting up of the compressor and the pump(s) of the heat pump, etc. Even after the start-up of the heat pump, there is of course an inevitable delay before heat from the heat pump reaches the HWSS. Likewise, some time is required for heat to be transferred, across any heat exchanger, between hot liquids supplied by the heat pump and water to be heated in the HWSS. Moreover, heat pumps are also typically configured to avoid starting more than 6 times per hour (it depends on manufacturer, but the figures are similar between manufacturers), and the processor 150 of the system will be aware of this constraint as it applies to the connected heat pump, and will also know about its own history of sending start instructions—and will factor this information into its decisions about the management of the various heat sources available to it.

The processor 150 of the HWSS is configured to provide a start signal to the heat pump based upon signals received from the flow sensor 170. As noted above, the installation is so configured that a time interval occurs between providing a start signal to the heat pump and the heating of water in the hot water system by the heat pump. This means that, absent a store of hot water or some other source of hot water, the turning on of a tap or shower fed by the HWSS will involve a long wait—of well over a minute, before hot water emerges from the outlet. This is both frustrating for users and a tremendous waste of water. The wait for hot water could be shortened by using an instantaneous water heater until such time as hot water arrives from the heat pump. But with such an arrangement, given that most instances of hot water usage from a tap (as opposed to from a shower) are less than 60 to 90 seconds, most of the hot water used would come from the instantaneous water heater (either electrically or gas powered), so that the green energy benefits of providing heat pump would largely be lost.

The processor 150 can modulate the power output of the electric element 220, based on a value received from the temperature sensor 210 to achieve the correct target temperature at the water outlet 130.

The ESA is provided as a means to bridge the gap between demanding hot water (i.e., the opening of the tap or shower control) and delivery of hot water heated by the heat pump. The system is preferably configured so that the ESA is charged with energy from the heat pump. The processor 150, using temperature information from the temperature sensors (210) and flow information from the flow sensor(s) 170, is configured preferentially to use the ESA to heat water supplied through the outlet 130. In this way, the processor 150 minimises its use of the instantaneous water heater 220.

Hence the processor is configured to provide a start signal to the heat pump based upon signals received from the flow sensor, the installation being so arranged that a time interval occurs between providing a start signal to the heat pump and the heating of water in the hot water system by the heat pump, the energy storage arrangement containing a mass of phase change material having a latent heat capacity sufficient to heat a predetermined quantity of water in the hot water system to a target temperature at least until water in the hot water system is heated by the heat pump, so that hot water can be supplied from the controllable outlet in the interval between the sending of the start signal and heating by the heat pump of water in the hot water system. The target temperature may be set based on the preferences of the users of the system, but will typically be in the region of say 40 to 45 Celsius. The predetermined quantity may be based on a desired duration of water supply at a flow rate chosen based either on the normal flow rates used for the outlet of the HWSS having the highest flow rate, or a lower rate that is considered to be both adequate and acceptable. The system and processor are preferably configured to allow these two variables (temperature and quantity) to be adjusted within preset limits (the preset limit values possibly being adjusted on the installation of the system).

Information from the flow sensor(s) 170 can tell the processor 150 whether, for example, an outlet that has been opened is a shower outlet, or a wash basin outlet. If the processor 150 determines that a shower outlet has been opened, the processor 150 will send a start signal to the heat pump, because it is expected to be worthwhile firing up the heat pump for the several minutes that a shower typically takes. Conversely, if the flow rate information supplied to the processor 150 suggests that a wash basin tap has been opened, the processor will determine that no start signal will be sent to the heat pump, because the heat pump is unlikely to be able to provide hot water before the wash basin tap is turned off again.

The processor 150 may be associated with logic, and for example a machine learning algorithm, that enable the processor to learn the behaviour of the occupants of the premises served by the HWSS, enabling the creation of a database from which the processor 150 can reliably predict the quantities and durations of hot water demand/usage according to time of day, day of the week, water outlet used, et cetera. Such an approach can be enhanced by, for example, providing further flow sensors associated with different water outlets of the HWSS (some or all of them, and preferably at least enabling the ready distinction between outlets with brief hot water demands—such as cloakroom hand basins, and those with prolonged hot water demands, such as showers and kitchen sinks). Additionally, by providing one or more flow sensors in the cold-water supply, it may be possible to identify cold water usage corresponding to flushing the toilet, for example, from which can be inferred the imminent demand for a brief supply of hot water for hand washing. The system processor 150 is preferably provided with logic to control all various heating assets (ESA(s), instantaneous water heater(s), and heat pump) in the most effective, economic and efficient way.

It can be considered that the ESA 140, the heat exchanger, the processor 150, the instantaneous water heater 220 and the flow and temperature transducers, 170 and 210, together constitute an interface unit 250 which interfaces between heat pump 120 and an in-building hot water system 110. FIG. 1 shows such an interface unit serving only to heat water for an in-building hot water system, but it will be appreciated that in many parts of the world there is a need for space heating within many buildings, and that it is attractive to use a heat pump for such space heating.

Typically, current combi boilers used even in small dwellings are large enough to provide 24 kW and more of hot water which is equivalent to shower or bath flow, but the typical space heating energy demand is much lower—typically around 4 kW. If one were to design a system in which both domestic hot water (DHW) and space heating were provided solely from a heat pump, one would need to specify a 24 kW heat pump to meet the DHW requirement, but such a system would be impractically large for typical 1-to-3 bedroom flats and houses, where for the most part the need is for space heating with only intermittent hot water usage.

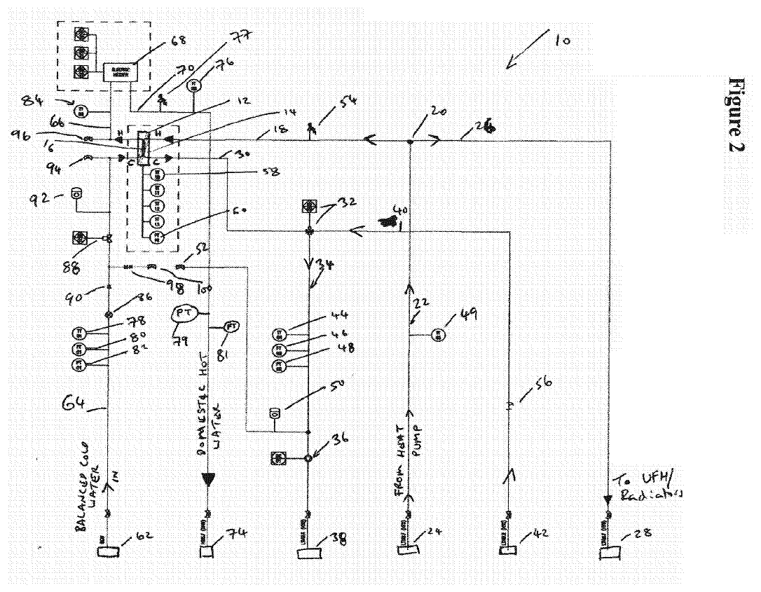

FIG. 2 shows schematically a potential arrangement of components of an interface unit 10 according to an aspect of the disclosure. The interface unit interfaces between a heat pump (not shown in this Figure) and an in-building hot water system. The interface unit includes a heat exchanger 12 comprising an enclosure (not separately numbered) within which is an input-side circuit, shown in very simplified form as 14, for connection to the heat pump, and an output-side circuit, again shown in very simplified form as 16, for connection to the in-building hot water system (not shown in this Figure). The heat exchanger 12 also contains a thermal storage medium for the storage of energy, but this is not shown in the Figure. In the example that will now be described with reference to FIG. 1 the thermal storage medium is a phase-change material.

Typically, the phase-change material in the heat exchanger has an energy storage capacity (in terms of the amount of energy stored by virtue of the latent heat of fusion) of between 2 and 5 MJoules, although more energy storage is possible and can be useful. And of course, less energy storage is also possible, but in general one wants to maximise (subject to practical constraints based on physical dimensions, weight, cost and safety) the potential for energy storage in the phase-change material of the interface unit 10.

The input side circuit 14 is connected to a pipe or conduit 18 which is in turn fed from node 20, from pipe 22 which has a coupling 24 for connection to a feed from a heat pump. Node 20 also feeds fluid from the heat pump to pipe 26 which terminates in a coupling 28 which is intended for connection to a heating network of a house or flat—for example for plumbing in to underfloor heating or a network of radiators or both. Thus, once the interface unit 10 is fully installed and operational, fluid heated by a heat pump (which is usually located outside the house or flat) passes through coupling 24 and along pipe 22 to node 20, from where, depending upon the setting of the 3-port valve 32, the fluid flow passes along pipe 18 to the input-side circuit 14 of the heat exchanger, or along pipe 26 and out through coupling 28 to the heating infrastructure of the house or flat.

Heated fluid from the heat pump flows through the input-side circuit 14 of the heat exchanger and out of the heat exchanger 12 along pipe 30. In use, under some circumstance, heat carried by the heated fluid from the heat pump gives up some of its energy to the phase change material inside the heat exchanger and some to water in the output-side circuit 16. Under other circumstances, as will be explained later, fluid flowing through the input-side circuit 14 of the heat exchanger actually acquires heat from the phase change material.

Pipe 30 feeds fluid that leaves the input-side circuit 14 to a motorized 3-port valve 32 and then, depending upon the status of the valve out along pipe 34 to pump 36. The pump 36 may serve to push the flow on to the external heat pump via coupling 38.

The motorized 3-port valve 32 also receives fluid from pipe 40 which receives, via coupling 42, fluid returning from the heating infrastructure (e.g. radiators) of the house or flat.

Between the motorized 3-port valve 32 and the pump 36 a trio of transducers are provided: a temperature transducer 44, a flow transducer 46, and a pressure transducer 48. In addition, a temperature transducer 49 is provided in the pipe 22 which brings in fluid from the output of the heat pump. These transducers, like all the others in the interface unit 10, are operatively connected to or addressable by a processor, not shown, which is typically provided as part of the interface unit—but which can be provided in a separate module.

Although not illustrated in FIG. 2, an additional electrical heating element may also be provided in the flow path between the coupler 24, which receives fluid from the output of the heat pump. This additional electrical heating element may again be an inductive or resistive heating element and is provided as a means to compensate for potential failure of the heat pump, but also for possible use in adding energy to the thermal storage unit (for example based on the current energy cost and predicted for heating and/or hot water. The additional electrical heating element is also of course controllable by the processor of the system.

Also coupled to pipe 34 is an expansion vessel 50, to which is connected a valve 52 by means of which a filling loop may be connected to top up fluid in the heating circuit. Also shown as part of the heating circuit of the interface unit are a pressure relief valve 54, intermediate the 3-port valve 32 and the input-side circuit 14, and a strainer 56 (to capture particulate contaminants) intermediate coupling 42 and the 3-port valve 32.

The heat exchanger 12 is also provided with several transducers, including at least one temperature transducer 58, although more (e.g. up to 4 or more) are preferably provided, as shown, and a pressure transducer 60. In the example shown, the heat exchanger includes 4 temperature transducers uniformly distributed within the phase change material so that temperature variations can be determined (and hence knowledge obtained about the state of the phase change material throughout its bulk). Such an arrangement may be of particular benefit during the design/implementation phase as a means to optimise design of the heat exchanger—including in optimising addition heat transfer arrangements. But such an arrangement may also continue to be of benefit in deployed systems as having multiple sensors can provide useful information to the processor and machine learning algorithms employed by the processor (either of just the interface unit, and/or of a processor of a system including the interface unit.

The arrangement of the cold-water feed and the hot water circuit of the interface unit 10 will now be described. A coupling 62 is provided for connection to a cold feed from a water main. Typically, before water from the water main reaches the interface unit 10, the water will have passed through an anti-syphon non-return valve and may have had its pressure reduced. From coupling 62 cold water passes along pipe to the output-side circuit 16 of the heat exchanger 12. Given that we provide a processor that is monitoring numerous sensors in the interface unit, the same processor can optionally be given one more task to do. That is to monitor the pressure at which cold water is delivered from the mains water supply. To this end, a further pressure sensor can be introduced in to the cold water supply line upstream of coupling 62, and in particular upstream of any pressure reducing arrangement within the premises. The processor can then continually or periodically monitor the supplied water pressure, and even prompt the owner/user to seek compensation from the water supply company if the water main supplies water at a pressure below the statutory minimum.

From the output-side circuit 16 water, which may have been heated by its passage through the heat exchanger, passes along a pipe 66 to an electrical heating unit 68. The electrical heating unit 68, which is under the control of the processor mentioned previously, may comprise a resistive or inductive heating arrangement whose heat output can be modulated in accordance with instructions from the processor.

The processor is configured to control the electrical heater, based on information about the status of the phase-change material and of the heat pump.

Typically, the electrical heating unit 68 has a power rating of no more than 10 kW, although under some circumstances a more powerful heater, e.g., 12 kW, may be provided.

From the electric heater 68, what will by now hot water passes along a pipe 70 to a coupling 74 to which the hot water circuit, including controllable outlets such as taps and showers, of the house or flat will be connected.

A temperature transducer 76 is provided after the electric heater 68, for example at the outlet of the electric heater 68 to provide information on the water temperature at the outlet of the hot water system. A pressure relief valve 77 is also provided in the hot water supply, and while this is shown as being located between the electric heater 68 and the outlet temperature transducer 76, its precise location is unimportant—as indeed is the case for many of the components illustrated in FIG. 2.

It will be appreciated that the processor can call on the heat pump to start either based on demand for space heating (e.g., based on a stored program either in the processor or in an external controller, and/or based on signals from one or more thermostats—e.g. room stats, external stats, underfloor heating stats) or demand for hot water. Control of the heat pump may be in the form of simple on/off commands, but may also or alternatively be in the form of modulation (using, for example, a ModBus).

As is the case with the heating circuit of the interface unit, a trio of transducers are provided along the cold-water feed pipe 64: a temperature transducer 78, a flow transducer 80, and a pressure transducer 82. Another temperature transducer 84 is also provided in pipe 66 intermediate the outlet of the output-side circuit 16 of the heat exchanger 12 and the electric heater 68. These transducers are again all operatively connected to or addressable by the processor mentioned previously.

Also shown on the cold-water supply line 64 are a magnetic or electrical water conditioner 86, a motorised and modulatable valve 88 (which like all the motorised valves may be controlled by the processor mentioned previously), a non-return valve 90, and an expansion vessel 92. The modulatable valve 88 can be controlled to regulate the flow of cold water to maintain a desired temperature of hot water (measured for example by temperature transducer 76).

Valves 94 and 96 are also provided for connection to external storage tanks for the storage of cold and heated water respectively. Optionally, at least the valve 96 may be used to recirculate hot water in the premises to reduce the hot water supply time, although this functionality might involve a higher energy usage—so that the functionality should be used with care. Finally, a double check valve 98 connects cold feed pipe 64 to another valve 100 which can be used with a filling loop to connect to previously mentioned valve 52 for charging the heating circuit with more water or a mix of water and corrosion inhibiter.

It should be noted that FIG. 2 shows various of the pipes crossing, but unless these crossing are shown as nodes, like node 20, the two pipes that are shown as cross do not communicate with each other, as should by now be clear from the foregoing description of the Figure.

Although not shown in FIG. 2, the heat exchanger 12 may include one or more additional electrical heating elements configured to put heat into the thermal storage medium. While this may seem counter intuitive, it permits the use of electrical energy to pre-charge the thermal storage medium at times when it makes economic sense to do so, as will now be explained.

It has long been the practice of energy supply companies to have tariffs where the cost of a unit of electricity varies according to the time of day, to take account of times of increased or reduced demand and to help shape customer behaviour to better balance demand to supply capacity.

Historically, tariff plans were rather coarse reflecting the technology both of power generation and of consumption. But increasing incorporation of renewable energy sources of electrical power—such as solar power (e.g. from photovoltaic cells, panels, and farms) and wind power, into the power generation fabric of countries has spurred the development of a more dynamic pricing of energy. This approach reflects the variability inherent in such weather-dependent power generation. Initially such dynamic pricing was largely restricted to large scale users, increasingly dynamic pricing is being offered to domestic consumers.

The degree of dynamism of the pricing varies from country to country, and also between different producers within a given country. At one extreme, “dynamic” pricing is little more than the offering of different tariffs in different time windows over the day, and such tariffs may apply for weeks, months, or seasons without variation. But some dynamic pricing regimes enable the supplier to change prices with a day's notice or less—so for example, customers may be offered today prices for half-hour slots tomorrow. Time slots of as short as 6 minutes are offered in some countries, and conceivably the lead time for notifying consumers of forthcoming tariffs can be reduced further by including “intelligence” in energy-consuming equipment.

Because it is possible to use short and medium term weather predictions to predict both the amount of energy likely to be produced by solar and wind installations, and the likely scale of power demand for heating and cooling, it becomes possible to predict periods of extremes of demand. Some power generation companies with significant renewable generation capacity have even been known to offer negative charging for electricity—literally paying customers to use the excess power. More often, power may be offered at a small fraction of the usual rate.

By incorporating an electric heater into an energy storage unit, such as a heat exchanger of systems according to the disclosure, it becomes possible for consumers to take advantage of periods of low-cost supply and to reduce their reliance on electrical power at times of high energy prices. This not only benefits the individual consumer, but it is also beneficial more generally as it can reduce demand at times when excess demand must be met by burning fossil fuels.

The processor of the interface unit has a wired or wireless connection (or both) to a data network, such as the Internet, to enable the processor to receive dynamic pricing information from energy suppliers. The processor also preferably has a data link connection (e.g., a ModBus) to the heat pump, both to send instructions to the heat pump and to receive information (e.g. status information and temperature information) from the heat pump. The processor has logic which enables it* to learn the behaviour of the household, and with this and the dynamic pricing information, the processor is able to determine whether and when to use cheaper electricity to pre-charge the heating system. This may be by heating the energy storage medium using an electrical element inside the heat exchanger, but alternatively this can be by driving the heat pump to a higher-than-normal temperature—for example 60 Celsius rather than between 40 and 48 Celsius. The efficiency of the heat pump reduces when it operates at higher temperature, but this can be taken into account by the processor in deciding when and how best to use cheaper electricity.

Because the system processor is connectable to a data network, such as the Internet and/or a provider's intranet, the local system processor can benefit from external computing power. So, for example the manufacturer of the interface unit is likely to have a cloud presence (or intranet) where computing power is provided for calculations of, for example, predicted:
occupancy;
activity;
tariff (short/long);
weather forecasts (which may be preferable to generally available weather forecasts because they can be pre-processed for easy use by the local processor, and they may also be tailored very specifically to the situation, location, exposure of the property within which the interface unit is installed);
identification of false positives and/or false negatives.

To protect users from the risk of scalding by overheated water from the hot water supply system it is sensible to provide a scalding protection feature. This may take the form of providing an electrically controllable (modulatable) valve to mix cold water from the cold water supply into hot water as it leaves the output circuit of the heat exchanger.

As one aspect of the disclosure, we propose to replace the combi gas boiler by the premanufactured set of heat exchangers, PCM energy bank, valves, pumps, and other hardware with the controller—all of them in the box which may match the shape and form of a gas combi boiler. Such an approach may lead to a significant decrease in the installation time and complexity of the plumbing work either to replace an existing gas combi boiler or for a new installation in place of a gas combi boiler.

FIG. 2 shows schematically what might be considered the “guts” of the interface unit, but does not show any container for these “guts”. An important application of interface units according to the disclosure is as a means to enable a heat pump to be used as a practical contributor to the space heating and hot water requirements of a dwelling that was previously provide with a gas-fired combination boiler (or which might otherwise have such a boiler installed), it will be appreciated that it will often be convenient both to provide a container both for aesthetics and safety, just as is the case conventionally with combi boilers. Moreover, preferably any such container will be dimensioned to fit within a form factor enabling direct replacement of a combi boiler—which are typically wall mounted, often in a kitchen where they co-exist with kitchen cabinets. Based on the form of a generally rectangular cuboid (although of course, for aesthetics, ergonomics, or safety, curved surfaces may be used for any or all of the surfaces of the container) with a height, width and depth, suitable sizes may be found in the approximate ranges: height 650 mm to 800 mm; width 350 mm to 550 mm; depth 260 mm to 420 mm; for example, 800 mm high, by 500 mm wide, and 400 mm deep, although larger, and in particular taller, units may be provided for installation where these can be accommodated.

One notable distinction of interface units according to the disclosure with respect to gas combi boilers is that while the containers of the latter generally have to be made of non-combustible materials —such as steel, due to the presence of a hot combustion chamber, the internal temperatures of an interface unit will generally be considerably less than 100 Celsius, typically less than 70 Celsius, and often less than 60 Celsius. So, it becomes practical to use other, less fire-resistant materials such a wood, bamboo, or even paper, in fabricating a container for the interface unit.

The lack of combustion also opens up the possibility to install interface units in locations that would generally never be considered as suitable for the installation of gas combi boilers—and of course, unlike a gas combi boiler, interface units according to the disclosure, do not require a flue for exhaust gases. So, for example, it becomes possible to configure an interface unit for installation beneath a kitchen worktop, and even to make use of the notorious dead spot represented by an under counter corner. For installation in such a location the interface unit could actually be integrated into an under counter cupboard—preferably through a collaboration with a manufacturer of kitchen cabinets. But greatest flexibility for deployment would be retained by having an interface unit that effectively sits behind some form of cabinet, the cabinet being configured to allow access to the interface unit. The interface unit would then preferably be configured to permit the circulation pump 36 to be slid out and away from the heat exchanger 12 before the circulation pump 36 is decoupled from the flow path of the input-side circuit.

Consideration can also be given to taking advantage of other space frequently wasted in fitted kitchens, namely the space beneath under-counter cupboards. There is often more a space with a height of more than 150 mm, and a depth of around 600 mm, with widths of 300, 400, 500, 600 mm or more (although allowance needs to be made for any legs supporting the cabinets). For new installations in particular, or where a combi boiler is being replaced along with a kitchen refit, it makes sense to use these spaces at least to accommodate the heat exchanger of the interface unit—or to use more than one heat exchanger unit for a given interface unit.

Particularly for interface units designed for wall mounting, although potentially beneficial whatever the application of the interface unit, it will often be desirable to design the interface unit as a plurality of modules. With such designs it can be convenient to have the heat exchanger as one of the of modules, because the presence of the phase-change material can result in the heat exchanger alone weighing more than 25 kg. For reasons of health and safety, and in order to facilitate one-person installation, it would be desirable to ensure that an interface unit can be delivered as a set of modules none of which weighs more than about 25 kg.

Such a weight constraint can be supported by making one of the modules a chassis for mounting the interface unit to a structure. For example, where an interface unit is to be wall mounted in place of an existing gas combi boiler, it can be convenient if a chassis, by which the other modules are supported, can first be fixed to the wall. Preferably the chassis is designed to work with the positions of existing fixing points used to support the combi boiler that is being replaced. This could potentially be done by providing a “universal” chassis that has fixing holes preformed according to the spacings and positions of popular gas combi boilers. Alternatively, it could be cost effective to produce a range of chassis each having hole positions/sizes/spacings to match those of particular manufacturer's boilers. Then one just needs to specify the right chassis to replace the relevant manufacturer's boiler. There are multiple benefits to this approach: it avoids the need to drill more holes for plugs to take fixing bolts—and not only does this eliminate the time needed to mark out, drill the holes and clean up, but it avoids the need to further weaken the structure of the dwelling where installation is taking place —which can be an important consideration given the low cost construction techniques and materials frequently used in “starter homes” and other low cost housing.

Preferably the heat exchanger module and the chassis module are configured to couple together. In this way it may be possible to avoid the need for separable fastenings, again saving installation time.

Preferably an additional module includes first interconnects, e.g. 62 and 74, to couple the output side circuit 16 of the heat exchanger 12 to the in-building hot water system.

Preferably the additional module also includes second interconnects, e.g. 38 and 24, to couple the input side circuit 14 of the heat exchanger 12 to the heat pump. Preferably the additional module also includes third interconnects, e.g. 42 and 28, to couple the interface unit to the heat circuit of the premises where the interface unit is to be used. It will be appreciated that by mounting heat exchanger to the chassis which is itself directly connected to the wall, rather than first mounting the connections to the chassis, the weight of the heat exchanger is kept closer to the wall, reducing the cantilever loading effect on the wall fixings that secure the interface unit to the wall.

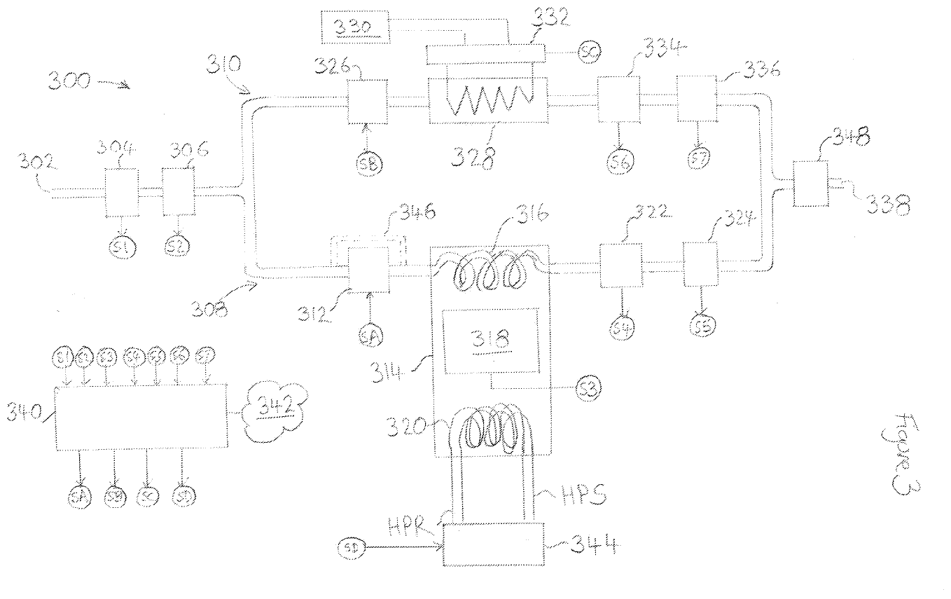

FIG. 3 shows a schematic diagram of an alternative arrangement of the hot water supply system (HWSS) in which the heat exchanger that heats water using the phase change material energy storage arrangement and the supplementary heater are connected in parallel. This provides significantly more flexibility than the previously-described series arrangement at the cost of more control valves and slightly more complexity.

The HWSS 300 comprises an inlet 302 for cold water which may be provided from the water mains supply or from a tank. The inlet 302 is connected in turn to a pressure sensor 304 having an output signal designated S1 and a temperature sensor 306 having an output signal designated S2. These, and other, sensor outputs are connected to a controller 340 via the correspondingly-numbered inputs but the connections are omitted from the figure for clarity. At the water outlet of the sensor 306 is a T-piece that supplies the water both to a path 308 and a path 310. Path 308 continues via a controllable valve 312 to an energy storage assembly (ESA) 314. The controllable valve 312 is responsive to a signal SA provided by the controller 340 to control the flow of water through the path 308. The connection to the controller is omitted from the figure for clarity.

The ESA comprises a heat exchanger 316 through which water in the path 308 can flow, a storage bank 318 and a heating coil 320 which connects via send pipe HPS and return pipe HPR to a heat pump 344. The storage bank 318 comprises phase change material (PCM) to store heat provided by the heat pump and incorporates a temperature sensor that provides a temperature output signal S3. Note that the ESA is shown purely schematically for clarity—in reality the heating coil, storage bank and heat exchanger will be arranged in a close thermal relationship. Further characteristics and refinements of the ESA will be common to the previously-described embodiments.

Path 308 continues via a temperature sensor 322 and a flow sensor 324 to a hot water outlet 338. Temperature sensor 322 provides a temperature output signal S4 and flow sensor 324 provides a flow rate output signal S5 and these signals are provided to the controller 340.

After the temperature sensor 306 and separation from path 308, path 310 continues via a controllable valve 326 to an electrical heater 328. The valve 326 is responsive to a control signal SB from the controller. The electrical heater is connected to an electricity supply, for example a mains supply 330, via a power electronic switch 332 responsive to a control signal SC from the controller 340. From an outlet of the electrical heater 328, the water path continues through a temperature sensor 334 which provides a temperature output signal 56 to the controller and a flow sensor 336 that provides a flow rate output signal S7 to the controller. From an outlet of the flow sensor 336 the path 310 rejoins the path 308 to provide a hot water outlet 338.

The controller 340 is provided with inputs S1 to S7 from the previously-described sensors and outputs SA, SB and SC to control the valves 312, 326 and the heater 328. The controller also provides a further output SD to control the start/stop of the heat pump 344. The controller is preferably also provided with a connection to the internet 342 to provide access to cloud computing, tariff data, weather information and so on.

The controller is operable in a similar manner to that of the earlier embodiments but the dual path, or parallel arrangement, provides extra flexibility. The controller may instruct the opening of valves 312, 326 in any proportion and the degree to which each valve is opened is subject to closed-loop control in response to the flow-rate signals from the flow sensors 324, 336. The valves are preferably controlled using a pulse-width modulation (PWM) technique in which the duty cycle of the drive signal is varied in response to the flow-rate signals from the sensors 324 and 336. The controller also controls the degree to which the electrical heater 328 is activated (if at all) via control line SC. Using these three control outputs, the controller 340 can ensure that the water temperature at the outlet 338 is at the desired temperature.

For example, assume that the temperature of the inlet water is 10 degrees Celsius and the desired output temperature of the water is 45 degrees Celsius. From knowledge of the temperature of the storage bank (signal S3), the controller determines that the heat exchanger can increase the temperature of the incoming water to 40 degrees. The controller instructs each valve 312, 326 to open to the same extent (meaning that the flow rate in paths 308, 310 will be equal) and calculates the power required by the electrical heater to heat the incoming water to 50 degrees C. The equal quantities of heated water from each path are combined at the hot-water outlet to provide water at the required temperature of 45 degrees C.

The controller has a great deal of flexibility in how the desired output temperature is achieved. For example, the controller may arrange for the flow rate in path 308 to be double that in path 310. To achieve the same output temperature as above, the output from the electrical heater will need to be at a temperature of 55 degrees so that, once the water paths are combined, the output temperature is 45 degrees C. This control strategy will extract more heat from the ESA 314 since more of the required water will be heated by ESA (rather than the electrical heater). Despite the fact that the electrical heater has to heat water to a higher temperature, this will use less electrical energy since less water has to be heated by it.

One key advantage over the series embodiment described previously is that the HWSS can provide water at a lower temperature than would be provided by the ESA and heat exchanger alone. The controller is capable of passing water along the path 310 without activating the heater 328. Cold water is thus mixed, at the outlet 338, with the water from the heat exchanger. Since less water is thus flowing through the heat exchanger, energy in the storage bank 318 is preserved.

Another key advantage is that the controller has the ability to heat the water solely or substantially using the electrical heater. This may be appropriate at times when electricity is cheap, for example due to a cheap tariff or locally-produced wind or solar energy. In the series embodiment, by contrast, all of the water to be heated flows through the ESA and necessarily depletes the energy stored therein.

The controller may instruct valves 312, 326 to open to a smaller degree than necessary to fully meet the hot water demand from a consumer in order to throttle the flow and reduce costs.

Valves 312 and 326 may be placed anywhere in their respective paths 308, 310 although it is preferred that they are placed on the inlet side (i.e. they control the flow of cold water) as this helps to reduce scaling in hard water areas and also helps to keep the valve operating coils cool. Pressure sensor 304 may be omitted in some circumstances as inadequate water pressure may be inferred from low flow rates detected at sensors 324 and 326 when valves 312 and 326 are open. Temperature sensor 306 may be omitted since the controller can operate in response to the outputs of temperature sensors 322 and 334 but it may be useful for the controller to know the temperature of the water at the inlet. This allows the controller to respond more quickly by making an initial estimate of flow through the two paths and the degree to which the supplementary heater is to be activated. Temperature sensor 322 at the outlet from the heat exchanger may be omitted as the controller 340 can infer the output temperature from the input temperature (signal S2), the flow rate (signal S5) and the temperature of the storage bank (signal S3).

The two temperature sensors 322 and 334 may be replaced by a single temperature sensor at the hot water outlet 338 but this will require the controller 340 to make some assumptions about the amount of heating provided by the heat exchanger 316 and may result in over-activation of the electrical heater 328 with consequent cost penalties.

Flow sensors 324 and 336 are useful in providing closed-loop control of the flow through the two paths 308, 310 (by modulating valves 312, 326 respectively) but may be omitted in the case of a temperature sensor at the hot-water outlet 338. In use, the water flow will of course be shared between the two paths 308 and 310 but the exact flow in each path will not be precisely known. This may also result in over-activation of the electrical heater 328.

If the requirement for hot water continues for more than a short time then the controller is arranged to activate the heat pump by way of the start signal SD. The controller may infer the duration of hot water demand from measuring the flow rate through one or both sensors 324, 336. If the flow rate is commensurate with a basin tap then it may be inferred that a consumer is washing their hands and demand for water will be brief. If the flow rate is commensurate with a shower or bath tap being opened then the controller may assume that the demand will last for some time and the heat pump 344 will be activated. Further strategies for control of the heat pump in response the user activity are similar to those discussed in the context of the first embodiment.

There may be times when it is more appropriate to heat the ESA 314 with an electrical heater (not shown) associated with the storage bank 318 than to operate the heat pump. This could be due to a really low electricity tariff or due to locally-produced green electricity. In this case the controller is arranged to activate the electrical heater until the temperature of the storage bank (temperature signal S3) reaches a desired temperature.

The status of the storage bank 318 may equally be determined by one or more pressure sensors as described with reference to FIG. 2.

In a preferred embodiment there is provided a pressure sensor 348 at the outlet of the HWSS which is connected to the controller. In response to a drop in pressure, the controller will infer that a water outlet has been opened and can open the valves and otherwise control the HWSS as appropriate. This allows the valves 312 and 326 to remain closed except when hot water is being provided.

Alternatively, flow through the HWSS may be detected when both valves 312 and 326 are closed by use of a small bypass path 346. When a water outlet in the premises is opened, some water will flow around the valve 312 which flow will be detected by flow sensor 324. The controller is then able to respond by opening at least one of the valves 312 and 326, determining the flow rate through the HWSS and instructing heating of the water as described above. The bypass path 346 is preferably narrow to minimise disruption to the operation of the HWSS. Although the bypass path is shown around valve 312 is could be arranged elsewhere, such as around valve 326 or is any other way that allows a flow sensor to detect water flow between the inlet 302 and outlet 338. Optionally, the bypass path could be closed by another valve (not shown) when the HWSS is operating. This valve would typically comprise a normally open valve which is then closed in response to a control signal from the controller.

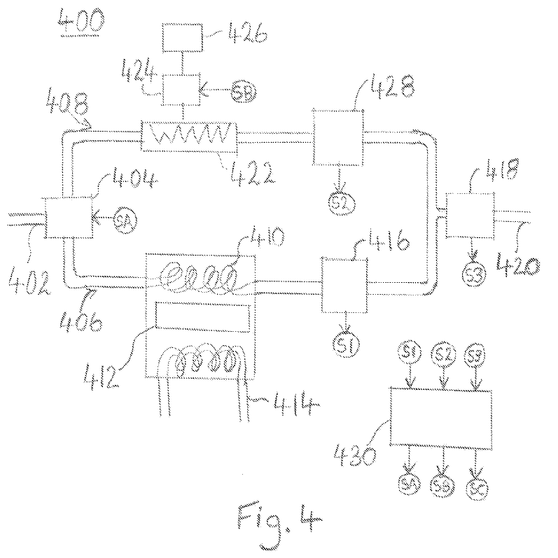

FIG. 4 shows another water heating arrangement 400 having separate flow paths through the ESA and supplementary heater but which comprises fewer components than that shown in FIG. 3.

The cold-water inlet 402 is connected to a three-way valve 404 which is controlled by a control signal SA. The valve connects the water inlet to a first path 406 and to a second path 408. The extent to which water is directed into each path is controlled by the control signal SA. At one extreme, all of the water is directed to path 406 and at the other extreme, all of the water is directed to path 408. By providing an intermediate signal (such as a PWM signal) the relative flow rates in the two paths can be controlled.

The path 406 continues to a Energy Storage Arrangement (ESA) as described with reference to FIG. 3. The ESA comprises a heat exchanger 410 (through which water in path 406 can flow), an energy storage bank 412 and a heating coil 414 for connection to a heat pump. Path 406 continues to flow sensor 416 which provides an output signal S1. The path 406 then recombines with path 408 and passes through a temperature sensor 418 to provide the hot water outlet 420. The temperature sensor provides a temperature output signal S3.

After the valve 404, path 408 continues to electrical heater 422 which is connected to mains supply 426 and controlled by switch 424 in response to control signal SB. After the electrical heater, path 408 continues to flow sensor 428 which outputs a flow signal S2.

A controller 430 receives the sensor outputs S1, S2 and S3 as well as providing the control outputs SA, SB and SC where SC provides a start signal for a heat pump (not shown).

In use, the valve 404 preferably adopts one of the extreme positions when it is not activated, although this is not vital. For example, if the valve adopts the position that connects the water inlet 402 with path 406 then the flow sensor 416 will detect when a water outlet has been opened on the premises. If the valve 404 adopts the other position then the flow sensor 428 will detect an outlet being opened. Even if the valve adopts an intermediate position when it is not being driven, then one or both of the flow sensors 416, 428 will detect an outlet being opened. Once the controller is aware of an outlet being opened then the temperature at the outlet of the HWSS will determine how to control the HWSS—predominantly by setting the valve 404 and potentially activating the supplementary heater 422.

By using a three-way valve 404 rather than the separate valves 312, 316 (FIG. 3), the problem of detecting whether a water outlet has been opened does not arise since some flow will always occur through the valve. Thus there is no requirement for a pressure sensor 348 (FIG. 3) or a bypass path 346 (FIG. 3). Some flexibility has been sacrificed, however, since this embodiment of the HWSS does not have the ability to throttle the flow rate as is possible when there is a separate valve in each path. This could be performed by adding a normally-open valve to each path but this would sacrifice simplicity.

While the inlet pressure sensor 304 (FIG. 3) has been omitted in the Figure, such a sensor could readily be added. A temperature sensor could also be provided in the storage bank 412 as for the previous embodiment. An internet connection may also be provided to the controller. The skilled reader will appreciate that certain other features of the embodiment shown in FIG. 3 could be incorporated into the embodiment of FIG. 4 to improve performance and economy as described above (albeit at the cost of more complexity).

The present application contains a number of self-evidently inter-related aspects and embodiments, generally based around a common set of problems, even if many aspects do have broader applicability. In particular the logic and control methods, whilst not necessarily limitedto operating with the hardware disclosed and may be more broadly applied, are all particularly suited to working with the hardware of the various hardware aspects and the preferred variants thereof. It will be appreciated by the skilled person that certain aspects relate to specific instances of other features and the preferred features described or claimed in particular aspects may be applied to others. The disclosure would become unmanageably long if explicit mention were made at every point of the inter-operability and the skilled person is expected to appreciate, and is hereby explicitly instructed to appreciate, that preferred features of any aspect may be applied to any other unless otherwise explicitly stated otherwise or manifestly inappropriate from the context. Again, for the sake of avoiding repetition, many aspects and concepts may be described only in method form or in hardware form but the corresponding apparatus or computer program or logic is also to be taken as disclosed in the case of a method or the method of operating the hardware in the case of an apparatus discussion. For an example of what is meant by the above, there are a number of features of both hardware and software relating to the combination of a fluid based (typically air source) heat pump and a phase change material and an electric supplementary heating element and control by a processor (within the unit or remote or both). Although this is the preferred application, most methods and hardware are more generally applicable to other heat pumps (thermoelectric and ground source) and to other renewable energy sources (a pump for a solar array for example) and to alternative supplementary heating (including the less preferred arrangement of a combustion heater such as a gas boiler, or even a less efficient higher temperature lower COP heat pump) and alternative thermal storage, including multi-temperature thermal storage arrays. Moreover, aspects which give particular arrangements for any of the components or their interaction can be used freely with aspects which focus on alternative elements of the system.

1. A hot water supply system for a domestic dwelling comprising:
a cold-water inlet and a hot-water outlet,
an energy storage arrangement, which contains a mass of energy storage medium for connection to a heat pump,
a heat exchanger associated with the energy storage arrangement,
a supplementary heater,
at least one temperature sensor arranged to detect the temperature of water at at least one of the hot-water outlet, the outlet of the heat exchanger and the outlet of the supplementary heater, and
a controller arranged to control at least the supplementary heater in response to a signal from the temperature sensor,
whereby the heat exchanger and the supplementary heater are arranged such that water from the cold-water inlet may be heated by passing through at least one of the heat exchanger and the supplementary heater and then provided to the hot-water outlet.

2. The hot water supply system of claim 1, wherein the heat exchanger is arranged in a first path having an inlet and an outlet and the supplementary heater is arranged in a second path having an inlet and an outlet,
the cold water inlet being coupled to the inlets of the first and second paths,
the hot water outlet being coupled to the outlets of the first and second paths,
the relative flow in the first and second paths being controlled by at least one control valve,
the controller being further arranged to control the at least one control valve in response to the signal from the temperature sensor.

3. The hot water supply system of claim 2, wherein a temperature sensor coupled to the controller is provided at the outlet of the first path and at the outlet of the second path.

4. The hot water supply system of claim 2, wherein the first and second paths each contain a flow sensor.

5. The hot water supply system of claim 4, wherein the at least one control valve is controlled using a PWM signal generated by closed-loop control in response the outputs of the respective flow sensors.

6. The hot water supply system of claim 2, wherein the at least one control valve comprises a valve arranged in the first path and a valve arranged in the second path.

7. The hot water supply system of claim 6, further comprising a second valve on each of the first and second paths, the second valves being connected in parallel with the first valves to provide redundant operation.

8. The hot water supply system of claim 2, wherein the controller is provided with inputs for at least two temperature sensors and at least two flow sensors and is arranged to determine, from the outputs of the temperature sensors and the flow sensors, whether water provided at the outlet is at a desired temperature.

9. The hot water supply system of claim 1, wherein the controller further comprises an input for electricity tariff information, the controller being arranged to determine, in response to the tariff information, the extent to which the supplementary heater is to be activated and the relative flow rates in the first and second paths.

10. The hot water supply system of claim 1, wherein the controller is further arranged to determine, in response to an output from at least one flow sensor, whether to generate a heat pump start signal.

11. The hot water supply system of claim 1, wherein the cold water inlet is coupled to an input to the heat exchanger, the supplementary heater is coupled to an output from the heat exchanger and the output of the supplementary heater is coupled to the hot water outlet.

12. The hot water supply system of claim 1, further comprising a heat pump connected to the energy storage arrangement.

13. The hot water supply system claim 1, wherein the capacity of the energy storage arrangement is at least 5 MJ.

14. The hot water supply system of claim 1, wherein the energy storage arrangement further comprises an electrical heater controlled by the controller.

15. The hot water supply system of claim 1, wherein the supplementary heater is an electrical heater.

16. A controller for controlling the hot water supply system of claim 2, the controller having inputs for at least one temperature sensor and at least two flow sensors and being arranged to determine, from the outputs of the temperature sensor and the flow sensors, the relative flow rates in the first and second paths.

17. The controller of claim 16, further comprising an input for electricity tariff information, the controller being arranged to determine, in response to the tariff information, the extent to which the supplementary heater is to be activated and the relative flow rates in the first and second paths.

18. The controller of claim 16, further arranged to determine, in response to an output from at least one flow sensor, whether to provide a heat pump start signal.
